(19) United States
(12) Patent Application Publication
(10) Pub. No.: US 2004/0228790 A1
(43) Pub. Date: Nov. 18, 2004

(54) Chlorine dioxide from a methanol-based generating system as a chemical feed in alkali metal chlorite manufacture

(76) Inventors: Mario Luis Costa, Hamilton (CA); Gerald Cowley, Mississauga (CA); Chunmin Pu, Mississauga (CA)

Correspondence Address: SIM & MCBURNEY, 330 UNIVERSITY AVENUE, 6TH FLOOR, TORONTO, ON, M5G 1R7, CA

(21) Appl. No.: 10/438,024

(22) Filed: May 15, 2003

(51) Int. Cl. C01B 11/10

(52) U.S. Cl. 423/475

(57) ABSTRACT

Alkali metal chlorite, particularly sodium chlorite, is produced with a level of purity superior to that expected based on the composition of the chlorine dioxide generator off-gas that is used as a raw chemical feed for chlorite manufacture. The off-gas is preferably drawn before it enters the chlorine dioxide absorption tower and is passed through a conditioning stage to then react in a liquid medium to produce an alkali metal chlorite solution from which the unreacted and produced gases are immediately separated.

### FIELD OF THE INVENTION

This invention relates to a process for the manufacture of alkali metal chlorite solutions with very low level of impurities by reduction of chlorine dioxide originating from a subatmospheric, methanol-based chlorine dioxide generation process.

### BACKGROUND TO THE INVENTION

Alkali metal chlorites are well known precursors of chlorine dioxide with a wide range of applications, mainly in water treatment, pulp bleaching and textile bleaching. Chlorites are prepared typically by the reaction of chlorine dioxide, a reducing agent and an alkali. An exhaustive discussion of various preparative methods for chlorite synthesis can be found in the basic textbook entitled: “Chlorine Dioxide. Chemistry and Environmental Impact of Oxychlorine Compounds” by W. J. Masschelein, 1979, pp. 130 to 145, the disclosure of which is incorporated herein by reference.

Various improvements to the basic concept of reacting chlorine dioxide with the reducing agent and alkali to form chlorite are disclosed in a number of U.S. patents discussed below.

U.S. Pat. Nos. 2,092,944 and 2,092,945 (Vincent) disclose the preparation of water soluble chlorites by reacting chlorine dioxide with an alkaline solution containing sulfur or a carbonaceous reducing agent.

U.S. Pat. No. 2,194,194 (Cunningham) discloses the use of metallic reducing agents for the preparation of chlorites.

U.S. Pat. No. 2,332,180 (Soule) discloses the use of hydrogen peroxide and alkali metal bicarbonate in chlorite synthesis. The same reducing agent is disclosed in the U.S. Pat. No. 2,616,783 (Wagner), related to the preparation of solid chlorite.

U.S. Pat. No. 3,101,248 (Hirschberg et al) discloses a process for chlorite synthesis involving the use of various alkali metal and alkaline earth metal amalgams as reducing agents.

U.S. Pat. No. 3,450,493 (Du Bellay et al) discloses a method for the manufacture of alkali metal chlorites, employing a continuous monitoring of redox potential and pH for correct process control.

U.S. Pat. No. 3,828,097 (Callerame) discloses a process for the preparation of chlorous acid, involving the use of nitrite in a column containing a cation exchange resin.

U.S. Pat. No. 4,087,515 (Miller) discloses the use of alkali metal amalgams as reducing agents whereby the process is carried out under an atmosphere of nitrogen gas to prevent an excessive build-up of chlorine dioxide.

U.S. Pat. No. 5,597,544 (Barber et al) and U.S. Pat. No. 5,639,559 (Mason et al) disclose a gas phase reaction between chlorine dioxide and reducing agent whereby the resulting chlorous acid is subsequently reacted with aqueous solution of the base, such as hydroxide, carbonate or bicarbonate to form chlorite in high yield.

A major drawback of all of the above described processes is that the final product has a high content of certain impurities, particularly carbonates and bicarbonates. According to the published literature (see, for example, previously cited Masschelein, p. 131, lines 10 and 11) a typical, commercial 80 wt % sodium chlorite product generally contains about 5 wt % sodium carbonate.

Such a high level of carbonates is detrimental at the point of use of the alkali metal chlorite, in particular when chlorite is converted to chlorine dioxide to be used for water disinfection or pulp bleaching. The presence of carbonates causes the formation of scale in the equipment employed for chlorine dioxide generation, resulting in higher operating costs and troublesome maintenance. While there are known methods for the purification of sodium chlorite from the carbonate impurity, they are very costly and often they create more problems than they solve. For example, a carbonate removal method based on the precipitation of lead carbonate (see Masschelein, p. 138) may result in the contamination of chlorite with highly poisonous lead compounds, rendering the product unsuitable for water treatment applications.

The problem of the minimization of the carbonate impurity content in the alkali metal chlorite was addressed in the recently issued U.S. Pat. No. 6,251,357 (Dick et al) assigned to the assignee thereof and the disclosure of which is incorporated herein by reference. It was proposed in that patent to manufacture high purity alkali metal chlorite by combining a chlorine dioxide generating system with a chlorite formation reactor, whereby both chlorine dioxide generating system and chlorite formation reactor are operated at subatmospheric pressure. The chlorine dioxide generating system found to be particularly useful in the most preferred embodiment of the above-mentioned invention was that involving the reduction of acidified chlorate solution with hydrogen peroxide. Unfortunately, hydrogen peroxide is a rather expensive reducing agent and therefore its use is not always economically viable. An alternative, less expensive reducing agent recommended in the U.S. Pat. No. 6,251,357 is chloride ion. Unfortunately, the use of the latter reducing agent has a major drawback, namely the co-production of a highly undesired chlorine by-product, which has to be separated from chlorine dioxide and separately utilized or otherwise disposed of.

There is still a need, therefore, to develop an economical process enabling the manufacture of alkali metal chlorite with a low impurity content, which does not have the drawbacks of the process disclosed in U.S. Pat. No. 6,251,357. Furthermore, there is a need to develop a relatively simple, less capital intensive process for chlorite manufacture that will benefit from the presence and availability of existing chlorine dioxide generators to minimize the installation expediture.

### SUMMARY OF THE INVENTION

Accordingly, the present invention is directed towards the manufacture of high purity alkali metal chlorite, preferably sodium chlorite, using a simple, less capital intensive process without any necessity for purification of the final product.

The present invention involves drawing the generator off-gases produced in commercial subatmospheric methanol-based chlorine dioxide processes into a reacting solution containing hydrogen peroxide and an alkali metal hydroxide, preferably sodium hydroxide, for the manufacture of the corresponding alkali metal chlorite. The process includes an optional gas conditioning stage before the drawn gases undergo chemical reaction, a gas-liquid contacting unit in which to conduct the chemical reaction and an optional gas-liquid disengagement stage immediately after the chlorite reactor.

Accordingly, in one aspect of the present invention, there is provided a method of producing an alkali metal chlorite having an improved purity compared to that expected based on the composition of chlorine dioxide generator off-gas, which comprises effecting generation of chlorine dioxide by reducing chlorate ions with methanol to chlorine dioxide in an aqueous acid reaction medium in a first reaction zone, reacting the chlorine dioxide with an aqueous solution of alkali metal hydroxide and hydrogen peroxide in a second reaction zone, and recovering an aqueous solution of alkali metal chlorite having an improved purity from the second reaction zone.

### BRIEF DESCRIPTION OF DRAWINGS

FIG. 1 is a schematic diagram of a chlorine dioxide generating system producing chlorine dioxide using R8® process from aqueous sodium chlorate, sulfuric acid and methanol;

FIG. 2 is a schematic diagram of a chlorite manufacturing process using chlorine dioxide generator off-gas, according to the generic process of the invention; and

FIG. 3 is a schematic diagram of a chlorite manufacturing process using chlorine dioxide generator off-gas, according to a preferred embodiment of the invention.

### GENERAL DESCRIPTION OF THE INVENTION

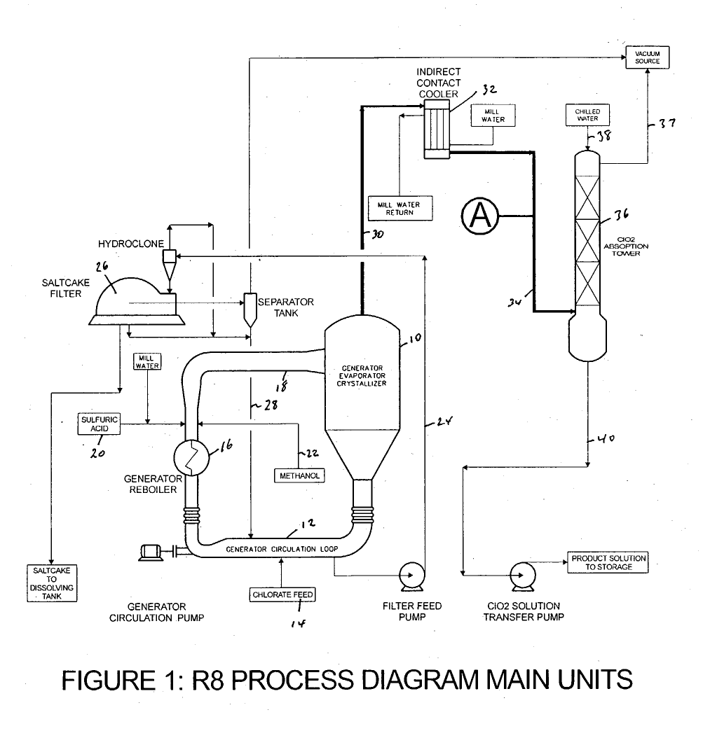

For the purpose of a better understanding of the present invention, a schematic diagram of a typical commercial subatmospheric pressure, methanol-based chlorine dioxide generator is depicted in FIG. 1. A full description of FIG. 1 appears below.

Based on the following empirical reaction equation:

3.093 NaClO₃+0.003 NaCl+2.04 H₂SO₄+1.011 CH₃OH [symbol] 3 ClO₂+0.0465 Cl₂+1.056 Na₃H(SO₄)₂+2.481 H₂O+0.216 CH₃OH+0.660 HCOOH+0.138 CO₂

the typical gaseous product composition during continuous operation can be estimated to be that present in the following Table 1:

TABLE 1
Typical Generator Off-Gas Composition

| Component | % Volume |
|---|---|
| ClO₂ | 7 |
| Cl₂ | 0.1 |
| H₂O(V) | 87 |
| CH₃OH | 0.5 |
| HCOOH | 1.5 |
| CO₂ | 0.3 |
| Air | 4.0 |

Since it was always assumed that reacting such chlorine dioxide generator off-gas mixture with hydrogen peroxide and alkali metal hydroxide would result in the formation of an alkali metal chlorite containing correspondingly high content of various contaminants (methanol, formic acid/formate, carbon dioxide/carbonates), the methanol-based process was never contemplated as a source of chlorine dioxide for the alkali metal chlorite manufacture.

Based on the typical gas compositions shown in Table 1 and assuming complete absorption/reaction of all gases with the hydrogen peroxide and alkali metal hydroxide, the resulting alkali metal chlorite product solution is expected to have the following levels of contaminants:

TABLE 2
Expected Contaminants Ratios in Alkali Chlorite Product Solution

| | | Contaminants Levels |
|---|---|---|
| Na₂CO₃/NaClO₂ | (mg/g) | 53.904 |
| Methanol/NaClO₂ | (mg/g) | 25.471 |
| NaCOOH/NaClO₂ | (mg/g) | 165.382 |

An alkali metal chlorite composition containing such high levels of impurities is not considered to be suitable for most applications of alkali metal chlorites.

However, it has now been surprisingly found that, by carrying out the chlorite manufacture according to the process of the present invention and described in detail below, the resulting product is significantly purer than originally anticipated. The process of the present invention permits the more economical methanol to be used as the reducing agent in the generator of the chlorine dioxide and in alkali metal chlorite manufacture.

Chlorine dioxide intended for use in the chlorite reactor can be gas-stripped, for example, air-stripped, from the chlorine dioxide product solution from the chlorine dioxide generator. However, in order to minimize organic carbon dioxide contamination and thereby provide chlorine dioxide having a lower proportion of components other than chlorine dioxide, the chlorine dioxide generator off-gas is preferably drawn from a point located between the Indirect Contact Cooler (ICC) exit and the absorption tower (S3) inlet (see point A in FIG. 1). In order to draw gas only, point A preferably is located at the top of the pipe. At this point, a large fraction of the methanol and formic acid load has been condensed into the water condensate generated in the ICC, leaving the off-gas stream as free of organic contaminants as it can possibly be.

A gas conditioning stage that may optionally follow off-gas withdrawal is intended to:

i) further reduce the content of organics by cooling the gases,

ii) reduce the content of other specific gas constituents, such as carbon dioxide, and

iii) scrubbing out possible liquid entrainment in order to deal with undesirable conditions frequently observed in commercial plant operation, such as generator liquor carried over the ICC in the form of a very fine mist.

Therefore, the gas conditioning equipment can consist of a demister, a gas washing column, a baffled box or another similar unit or combination thereof. The liquid circulated in gas washing columns is typically water, preferably chilled. Other suitable aqueous media are alkali metal and alkali earth metal hydroxide solutions, which offer the possibility of reducing the content levels of both carbon dioxide and chlorine gas.

The chemical reaction to form alkali metal chlorite can be carried out, preferably under subatmospheric pressure, generally in the range of about 50 to about 500 mmHg, preferably about 50 to about 200 mmHg, in any gas-liquid contacting unit, such as a conventional spray column or packed tower. The pH of the reaction medium entering the reactor generally is maintained in the range of about 11.8 to about 13.0, preferably about 12.0 to about 12.6. Hydrogen peroxide generally is utilized in excess of that required for the stoichiometric reaction of alkali metal hydroxide, hydrogen peroxide and chlorine dioxide. The hydrogen peroxide excess may be maintained using a potentiometric (ORP) measurement. The ORP values, which are pH dependent, are generally maintained in the range of about −30 to about −200 mV vs Ag/AgCl, preferably about 90 to about 150 mV vs Ag/AgCl. The alkali metal chlorite-forming reaction generally is carried out at a temperature of about 25 to about 40° C., preferably about 25 to about 35° C.

The preferred embodiment of the process involves the use of a liquid eductor to simultaneously provide the vacuum source needed for gas withdrawal and the physical environment for the chemical reaction to take place. The use of the vacuum source is intended to provide just the very minimum contact time required by the fast chlorite formation reaction while at the same time minimizing the possibility for the relatively slow carbon dioxide absorption process to proceed. The use of a liquid eductor may represent a major improvement over alternative gas-liquid contact equipment in terms of the cost and simplicity due to its double function as a vacuum source and a reactor, and in terms of effectiveness as a result of its particularly short gas-liquid contact time.

In order to further minimize the contact time between reactant gases and chlorite reactor solution, a gas disengagement stage may be introduced immediately after the chemical reactor. Any conventional gas-liquid separating equipment can be used, with the preferred embodiment consisting of a centrifugal-type separator.

It is particularly beneficial to operate the process of the invention by utilizing in the chlorite manufacture only a fraction of the chlorine dioxide generated in the chlorine dioxide generator, with the remaining chlorine dioxide being directed to other suitable applications, for example, bleach plant operations. Such an operation allows for a more efficient distribution of impurities typically present in the gaseous product of the sub-atmospheric, methanol-based chlorine dioxide generator, with the majority of impurities going to the bleach plant.

Another particularly beneficial modification to the common practice of the methanol-based process operation is the maximization of the Indirect Contact Cooler spray shower flow rate. Such practice allows every chlorine dioxide generating system to minimize the level of contaminants in the off-gas stream at the point of exit of the ICC.

In addition to the above-mentioned distribution of the gaseous product of the chlorine dioxide generator between the chlorite reactor and the bleach plant, there are other possible steps that can be taken in order to minimize the level of contaminants, especially carbonate, in the final chlorite product solution. Such additional steps include:

i) maintaining just the minimum alkalinity required for the ClO₂+H₂O₂+NaOH reaction in the chlorite reactor,

ii) maintaining the highest possible ClO₂/CO₂ gas feed ratio, and

iii) minimizing gas-liquid contact time.

Proper process control strategy and design can be very important regarding the first two possibilities, while the third possibility can best be fulfilled by the use of a liquid eductor as the reactor followed by immediate gas disengagement in a suitable separator.

Incorporation of the process equipment of this invention (gas conditioning, chlorite reactor, etc) with an existing chlorine dioxide generator also makes it possible to optimize ClO₂ plant operation by minimizing the need for:

i) stop/stand-by/re-start sequences when pulp bleaching is interrupted (by diverting ClO₂ production to chlorite manufacture) and

ii) changes in chemical feed rates by changing instead the fraction of ClO₂ produced diverted to chlorite manufacture.

Since the targeted purity of the alkali metal chlorite product is partially dependent on the chlorine dioxide generation process, the efficiency with which the process is run will affect the output. For a subatmospheric, methanol-based process the lowest carbonate level in the chlorite product solution can be expected from a process run under some degree of excess methanol, which will lead to the highest ClO₂/CO₂ ratios in the gas phase. On the other hand, such a situation not only results in an increased operating cost but also leads to high, undesirable organic content in the off-gas and therefore, potentially, in the chlorite product. In practice, an optimum balance must be determined based on the chlorite product specific requirements.

The objective of pure alkali metal chlorite manufacture is largely dependent on the attributes of the chlorine dioxide generation processes, and therefore subatmospheric ones offer the best opportunities for success according to the present invention. But with varying degrees of purity, the invention is also applicable to atmospheric chlorine dioxide generating processes as well, and to all types of reducing agents and of catalysts (if any at all) used in the various commercial chlorine dioxide processes available regardless of pressure conditions. It is understood that methanol used as a reducing agent in the process of the invention can be readily substituted, at least in part, by other alcohols, such as ethanol or iso-propanol.

### DESCRIPTION OF PREFERRED EMBODIMENTS

Referring to FIG. 1, there is shown therein a schematic diagram of a typical commercial subatmospheric pressure, methanol-based chlorine dioxide generator. As seen therein, a single vessel generator evaporator crystallizer 10 is provided connected at the lower end to a generator recirculation loop 12 to which chlorate reactant is fed by line 14, and connected to a generator reboiler 16. The generator reboiler 16 is connected at the downstream side to a feed pipe 18 to the generator 10, to which methanol and sulfuric acid are fed by lines 20 and 22 respectively.

A slurry of by-product crystalline sodium acid sulfate in spent reactor liquor is removed from the recirculation loop 12 by line 14 and passed to a salt cake filter 26 wherein the crystalline sodium sesqui-sulfate is separated from the spent reactor liquor and returned to the recirculation loop by line 28.

The gaseous products of the reaction, mainly steam and chlorine dioxide, is fed by line 30 to an indirect contact cooler 32 wherein steam is condensed. The gaseous chlorine dioxide is fed by line 34 to a chlorine dioxide absorption tower 36 to which vacuum is applied by line 37 and wherein the chlorine dioxide is dissolved in chilled water fed by line 38. The resulting chlorine dioxide solution is passed by line 40 to storage.

In the process effected in the reactor 10, sodium chlorate, methanol and sulfuric acid react in an aqueous acid reaction medium maintained therein under a subatmospheric pressure to form gaseous chlorine dioxide and by-product crystalline sodium sesqui-sulfate and according to the empirical reaction equation given above.

The aqueous acid reaction medium generally has a sodium chlorate concentration of about 0.5 to about 3.5 M, preferably about 1.5 to about 2.5 M, and a total acid normality of about 7 to about 10 N, preferably about 7.5 to about 8.5 N. Methanol is fed an amount necessary to produce the chlorine dioxide. The aqueous acid reaction medium generally is maintained at a temperature of about 50 to about 90° C., preferably about 65 to about 75° C., while a subatmospheric pressure of about 50 to about 400 mmHg, preferably about 100 to about 200 mmHg, is applied to the reaction zone.

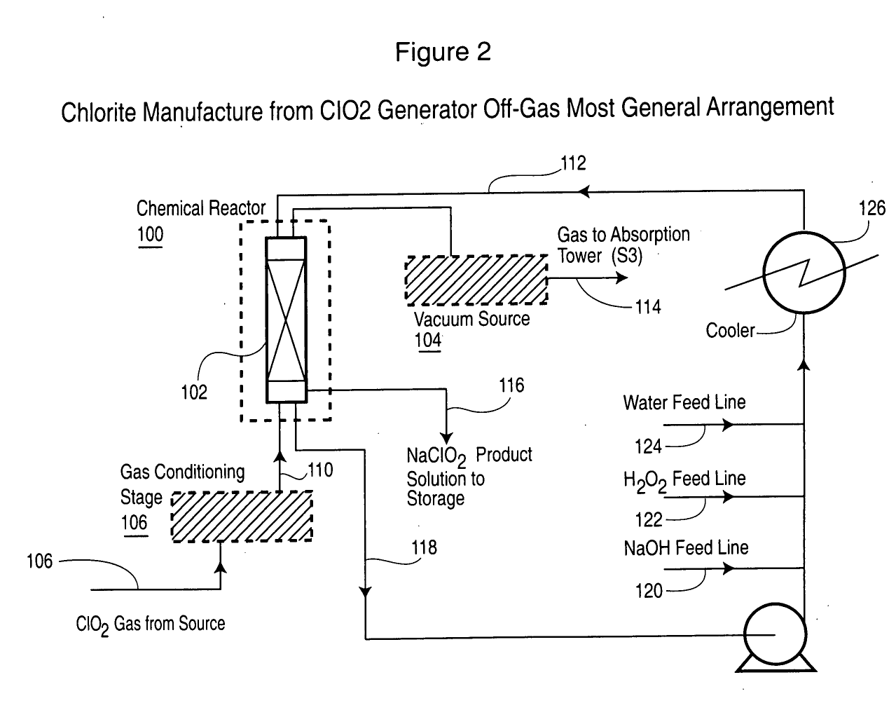

Referring to FIG. 2, there is shown therein a schematic of a process for producing sodium chlorate, in accordance with one embodiment of the invention. As seen therein, sodium chlorite product is formed in chemical reactor 100 which, in the embodiment illustrated, is a packed tower 102. The tower 102 is maintained under vacuum by a vacuum source 104.

Gaseous chlorine dioxide is fed from the chlorine dioxide generator by line 106 through a gas conditioning stage 108, during which any of the options referred to above may be effected, before passage to the lower end of the chemical reactor 100 by line 110. An aqueous solution of sodium hydroxide and hydrogen peroxide is fed to the upper end of the chemical reactor 100 by line 112 for reaction therein with the gaseous chlorine dioxide. Off-gas from the vacuum source 104 is fed by line 114 to the gas absorption tower (S3) of the chlorine dioxide generator (see FIG. 1).

Sodium chlorite product solution is drawn from the lower end of the chemical reactor 100 by line 116. The remainder of the liquid from the chemical reactor is recirculated by line 118 to make-up feed lines 120, 1.12 and 124 respectively for sodium hydroxide, hydrogen peroxide and water, following which the reaction solution is fed through a cooler 126 to the feed line 112.

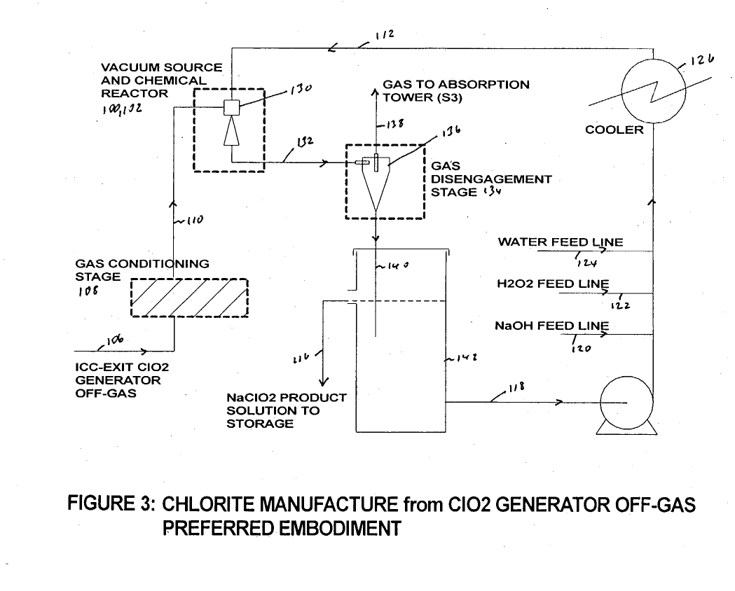

Referring to FIG. 3, wherein the same reference numerals are used as in FIG. 2, where appropriate, a preferred embodiments of the invention is illustrated, in which the chemical reactor 100 and vacuum source 104 are replaced by a vacuum eductor 130. The conditioned gaseous chlorine dioxide in line 110 is fed to the gas side of the eductor 130 while the aqueous reaction solution of sodium hydroxide and hydrogen peroxide in line 112 is fed to the liquid side of the eductor 130. Residual gas and aqueous sodium chlorite reaction product are passed from the eductor by line 132 to a gas disengagement stage 134 in the form of a cyclone separator 136. Separated gas from the cyclone gas disengagement is forwarded by line 138 to the absorption tower (S3) of the chlorine dioxide generator (see FIG. 1). Separated liquid product is passed by line 140 to a collector vessel 142 from which the product aqueous sodium chlorite solution passes by line 116 to storage.

### EXAMPLE

This Example illustrates the preparation of sodium chlorite with low carbonate and organic content according to the process of the invention.

A commercial, subatmospheric, methanol-based ClO₂ generator (R8) as shown in FIG. 1 was run in the vicinity of its nominal capacity (20 MTPD) and within its typical liquor composition and pressure/temperature operating ranges: 7.5 to 8.5 N acidity, 1.8 to 2.2 M sodium chlorate concentration, 119 to 121 mmHg absolute pressure and 69 to 71° C.

Methanol consumption was 0.174 g/g ClO₂, ICC exit temperature was 10° C. and ClO₂ product solution strength was 12.5 g/L.

Following several hours of steady operation, an off-gas sample started to be continuously withdrawn from a port at the top of the ICC exit line (See point A in FIG. 1). The gases were directed into a 150 mL gas washing bottle (pretreatment stage) followed by a chlorite reaction bottle filled with 100 mL water+37 mL 50% NaOH+17 mL 50% H₂O₂. A small laboratory water eductor was used to pull the gases through the experimental setup.

During three separate tests conducted, the NaClO₂ concentration in the reaction bottle was allowed to build up over lengths of time ranging from 52 to 140 minutes. The pretreatment stages for the three individual tests consisted of water, CaCl₂ solution and a combination of both. The chlorite reactor solution composition was sampled for analysis at the end of each test to find that the average compositions were: 269.3 g/L NaClO₂, 291.7 mg/L methanol, 2.19 g/L sodium formate and 2.12 g/L Na₂CO₃.

Therefore, the relevant performance parameters were:

Na₂CO₃/NaClO₂ 7.89 mg/g (reduced from 53.904 mg/g as per TABLE 2)

Methanol/NaClO₂ 1.08 mg/g (reduced from 25.471 mg/g as per TABLE 2)

NaCOOH/NaClO₂ 8.14 mg/g (reduced from 165.382 mg/g as per TABLE 2)

These data show an unexpected result in terms of a very high purity of the final product.

### Summary of Disclosure

In summary of this disclosure, aqueous alkali metal chlorite is produced having a low level of impurities, specifically carbonates and organics, from chlorine dioxide produced by a methanol-based process. Modifications are possible within the scope of this invention.

What we claim is:

1. A method of producing an alkali metal chlorite having an improved purity compared to that expected based on the composition of chlorine dioxide generator off-gas, which comprises:
effecting generation of chlorine dioxide by reducing chlorate ions with methanol to chlorine dioxide in an aqueous acid reaction medium in a first reaction zone,
reacting said chlorine dioxide with an aqueous solution of alkali metal hydroxide and hydrogen peroxide in a second reaction zone, and
recovering an aqueous solution of alkali metal chlorite having an improved purity from said second reaction zone.

2. The method of claim 1 wherein sodium chlorate and methanol are reacted in an aqueous acid reaction medium containing sulfuric acid at the boiling point of the reaction medium while a subatmospheric pressure is applied to said first reaction zone to provide a gaseous mixture of chlorine dioxide, steam and volatile reaction by-products.

3. The method of claim 2 wherein said gaseous mixture of chlorine dioxide, steam and volatile reaction by-products is cooled to condense said steam and at least a significant proportion of said volatile by-products to provide said chlorine dioxide for reaction with said aqueous solution of alkali metal hydroxide and hydrogen peroxide.

4. The method of claim 3 wherein said chlorine dioxide is subjected to one or more conditioning steps effected to:
(i) further reduce the contents of organics by cooling the chlorine dioxide,
(ii) reduce the content of carbon dioxide, and/or
(iii) remove any generator liquor carry-over.

5. The method of claim 1 wherein said reaction of chlorine dioxide, alkali metal hydroxide and hydrogen peroxide is effected while a subatmospheric pressure is applied to said second reaction zone.

6. The method of claim 5 wherein said subatmospheric pressure is provided by a liquid eductor to which an aqueous solution of alkali metal hydroxide and hydrogen peroxide is fed to a liquid inlet while said chlorine dioxide is fed to a gaseous inlet, whereby said liquid eductor constitutes said second reaction zone.

7. The method of claim 6 wherein, following reaction in said liquid eductor the reaction products are forwarded from an outlet from said liquid eductor to a gas-liquid separator wherein the aqueous solution of alkali metal chlorate is separated from residual unreacted gases.

8. The method of claim 7 wherein said alkali metal hydroxide is aqueous sodium hydroxide.

9. The method of claim 1 wherein methanol is substituted, at least in part, by ethanol or iso-propanol.
